(19) United States
(12) Patent Application Publication
(10) Pub. No.: US 2022/0247295 A1
(43) Pub. Date: Aug. 4, 2022

(54) ACTUATOR

(71) Applicant: NIDEC SANKYO CORPORATION, Nagano (JP)

(72) Inventors: Yuichi TAKEI, Nagano (JP); Shinji HATANO, Nagano (JP)

(73) Assignee: NIDEC SANKYO CORPORATION, Nagano (JP)

(21) Appl. No.: 17/581,962

(22) Filed: Jan. 23, 2022

(30) Foreign Application Priority Data
Jan. 29, 2021 (JP) 2021-013384

(51) Int. Cl. H02K 33/18; H02K 5/06; H02K 5/10; H02K 9/22

(52) U.S. Cl. CPC H02K 33/18; H02K 9/223; H02K 5/10; H02K 5/06

(57) ABSTRACT

An actuator includes a cover that houses a movable body. The cover is divided into two parts: a first cover member and a second cover member. A first comb teeth portion disposed at the end of the first cover member and a second comb teeth portion disposed at the end of the second cover member slidably engage each other in a first direction. Therefore, the first and second cover members can be assembled by adjusting the gap between the cover and the movable body in which a connecting member connecting the movable body and the cover is disposed, so that the dimensional accuracy of the gap between the cover and the movable body can be improved. Therefore, the movable body and the support body can be securely connected, and assembly defects can be avoided. Moreover, excess compression of the connecting member can be avoided.

### CROSS REFERENCE TO RELATED APPLICATIONS

The present invention claims priority under 35 U.S.C. § 119 to Japanese Application No. 2021-013384 filed on Jan. 29, 2021, the entire content of which is incorporated herein by reference.

### BACKGROUND

### Field of the Invention

At least an embodiment of the present invention relates to an actuator that vibrates a movable body.

### Description of the Related Documents

Japanese Unexamined Patent Publication No. 2020-203247 (JP 2020-203247) discloses an actuator used as a device to report information through vibration. The actuator of JP 2020-203247 includes a support body including a square cover, a movable body vibrating relative to the support body inside the cover, and a connecting member that connects the support body and the movable body. The movable body includes a permanent magnet and a yoke, and the support body includes a coil holder fixed to the cover and a coil held by the coil holder. The permanent magnet and the coil face each other inside the yoke in a direction orthogonal to the vibration direction of the movable body. The outer circumferential surface of a yoke faces a flat plate portion of a cover in a direction orthogonal to the vibration direction of a movable body. The connecting member is a gelatinous member disposed between the flat plate portion of the cover and the yoke. When the movable body vibrates, the connecting member (gelatinous member) deforms in the shear direction.

In the actuator of JP 2020-203247, the cover is divided into two parts: a first cover part covering the movable body from one side in a direction orthogonal to the vibration direction, and a second cover part covering the movable body from the other side in a direction orthogonal to the vibration direction. The first cover part and the second cover part are positioned by fitting a plate portion formed in the side surface of the first cover part by lancing into a hole formed in the side surface of the second cover part, and are fixed by adhesion method or the like. Therefore, the first and second cover parts are positioned by the edges of both cover parts (the edge of the plate portion of the first cover part and the edge of the hole of the second cover part) coming into contact with each other.

However, positioning of the first cover part and the second cover part by causing the edges of the cover parts to come into contact with each other as in JP 2020-203247 leads to variation in the gap between the flat plate portion of the cover part and the yoke where a connecting member is disposed, due to variation in the dimensions of the parts. Therefore, the gap between the cover parts and the yoke is larger than the thickness of the connecting member, and the connecting member (gelatinous member) may separate from the cover parts or the yoke. Moreover, there is a risk that the connecting member may be compressed more than necessary. Therefore, there is a possibility that the vibration characteristics as per the design value cannot be achieved.

In view of the above problems, an object of at least an embodiment of the present invention is to improve the dimensional accuracy of a gap between a movable body and a support body in which a connecting member is disposed.

### SUMMARY

In order to solve the above problem, the actuator of at least an embodiment of the present invention includes a movable body; a support body including a cover enclosing the movable body; a connecting member having at least one of elasticity and viscoelasticity and being connected to both the movable body and the support body; and a magnetic drive circuit, the cover including a first cover member having a first flat plate portion; and a second cover member having a second flat plate portion facing the first flat plate portion in a first direction, the magnetic drive circuit vibrating the movable body disposed between the first flat plate portion and the second flat plate portion in a second direction intersecting the first direction, the connecting member including a first connecting sub-member disposed between the movable body and the first flat plate portion and a second connecting sub-member disposed between the movable body and the second flat plate portion, the first cover member including a first side plate portion extending from an edge of the first flat plate portion toward the second cover member, a distal edge of the first side plate portion including extending portions extending in the first direction, the second cover member including a second side plate portion extending from an edge of the second flat plate portion toward the first cover member, a distal edge of the second side plate portion including notched portions in which the extending portions are slidably fitted in the first direction.

According to at least an embodiment of the present invention, the cover constituting the support body includes the first cover member and the second cover member joined together, and the movable body is disposed between the first flat plate portion of the first cover member and the second flat plate portion of the second cover member. The movable body and the support body are connected by the first connecting sub-member disposed between the first flat plate portion and the movable body and the second connecting sub-member disposed between the second flat plate portion and the movable body. The first cover member and the second cover member are assembled so that the extending portions disposed on the first cover member are slidably fitted in the first direction to the notched portions of the second cover member. Therefore, since the distance between the first flat plate portion and the second flat plate portion can be finely adjusted, the dimensional accuracy of the gap in which the connecting members are disposed can be increased even if the dimensional accuracy of the parts is low.

In at least an embodiment of the present embodiment, it is preferred that the distal edge of the first side plate portion be provided with a first comb teeth portion in which the extending portions are arrayed at regular intervals; the distal edge of the second side plate portion be provided with a second comb teeth portion in which the notched portions are arrayed at regular intervals; and the second comb teeth portion engage the first comb teeth portion in a manner slidable in the first direction. In this way, if the comb teeth portions are engaged with each other, the assembled first cover member and second cover member do not readily shift in a direction intersecting the first direction. Therefore, the first cover member and the second cover member can be permanently fixed together through ready work, such as welding. Moreover, the work of adjusting the distance between the first flat plate portion and the second flat plate portion can be readily performed while measuring the vibration characteristics before the first cover member and the second cover member are to be permanently fixed.

In at least an embodiment of the present invention, it is preferred that the first cover member and the second cover member be joined by welding widthwise edges of the extending portions and widthwise edges of the notched portions. In this way, even when the first cover member and the second cover member are shifted in the first direction, they can be joined. Furthermore, reduction in the joining strength due to the shift of the first cover member and the second cover member in the first direction can be avoided.

In at least an embodiment of the present invention, it is preferred that the first side plate portion extend cylindrically in the first direction from the outer circumferential edge of the first flat plate portion, and the second side plate portion extend cylindrically in the first direction from the outer circumferential edge of the second flat plate portion. In this way, the cover in a sealed form can be readily assembled by joining together the distal edges of the cylindrical portions. The sealed form of the cover can prevent the entering of foreign matter into the cover.

In at least an embodiment of the present invention, it is preferred that the movable body include a yoke having a first plate portion extending in the first direction and a second plate portion facing the first plate portion in a third direction intersecting the first direction and the second direction; the support body include a coil holder disposed between the first plate portion and the second plate portion; the magnetic drive circuit include a coil held by the coil holder, and a magnet fixed to at least one of the first plate portion and the second plate portion and facing the coil in the third direction; the yoke include two connecting portions connecting the first plate portion and the second plate portion and facing each other in the second direction across the coil and the magnet; the first connecting sub-member connects one of the two connecting portions to the first flat plate portion; and the second connecting sub-member connect the other one of the two connecting portions to the second flat plate portion. In this way, the magnetic drive circuit can include the magnet disposed in the movable body and the coil disposed in the support body arranged in a direction intersecting the vibration direction. By enclosing the magnet and the coil by the yoke, the magnetic efficiency can be increased.

In at least an embodiment of the present invention, it is preferred that the coil holder include a coil holding portion disposed between the first plate portion and the second plate portion; and two guide portions being erected in the third direction from both ends in the second direction of the coil holding portion and extending in the first direction on both sides in the second direction of the yoke; the first side plate portion have a first side plate portion first surface and a first side plate portion second surface facing each other in the second direction; the second side plate portion have a second side plate portion first surface and a second side plate portion second surface facing each other in the second direction; one of the two guide portions be in contact with the first side plate portion first surface and the second side plate portion first surface; and the other one of the two guide portions be in contact with the first side plate portion second surface and the second side plate portion second surface. In this way, the two guide portions can guide the insertion of the coil holder into the first cover member and the second cover member. Therefore, the assembly of the support body is easy, and the positioning of the coil is possible.

In at least an embodiment of the present invention, it is preferred that the cover and the coil holder be composed of metal. In this way, the heat of the coil is dissipated from the cover through the coil holder. Therefore, the amount of heat dissipation can be increased, and the temperature rise of the coil can be suppressed.

According to at least an embodiment of the present invention, the cover constituting the support body includes the first cover member and the second cover member joined together, and the movable body is disposed between the first flat plate portion of the first cover member and the second flat plate portion of the second cover member. The movable body and the support body are connected by the first connecting sub-member disposed between the first flat plate portion and the movable body and the second connecting sub-member disposed between the second flat plate portion and the movable body. The first cover member and the second cover member are assembled so that the extending portions disposed on the first cover member are slidably fitted in the first direction to the notched portions of the second cover member. Therefore, since the distance between the first flat plate portion and the second flat plate portion can be finely adjusted, the dimensional accuracy of the gap in which the connecting members are disposed can be increased even if the dimensional accuracy of the parts is low.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an external view of an actuator to which at least an embodiment of the present invention is applied.

FIG. 2 is a cross-sectional view of the actuator taken along line A-A in FIG. 1.

FIG. 3 is a cross-sectional view of the actuator taken along line B-B in FIG. 1.

FIG. 4 is an exploded view of the actuator with a cover disassembled.

FIG. 5 is an exploded view of the actuator with the cover and the movable body disassembled.

FIG. 6 illustrates an assembly method of the cover.

FIG. 7 illustrates welded portions of first and second comb teeth portions.

### DETAILED DESCRIPTION

Embodiments of the present invention will now be described with reference to the accompanying drawings. In the following description, a first direction Y, a second direction X, and a third direction Z are directions that intersect each other. A first side in the second direction X is denoted as X1, a second side in the second direction X is denoted as X2. A first side in the first direction Y is denoted as Y1, and a second side in the first direction Y is denoted Y2. A first side in the third direction Z is denoted as Z1, and a second side in the third direction Z is denoted as Z2. The third direction Z, the second direction X, and the first direction Y are orthogonal to each other in the present embodiment. The second direction X is the vibration direction of a movable body 6.

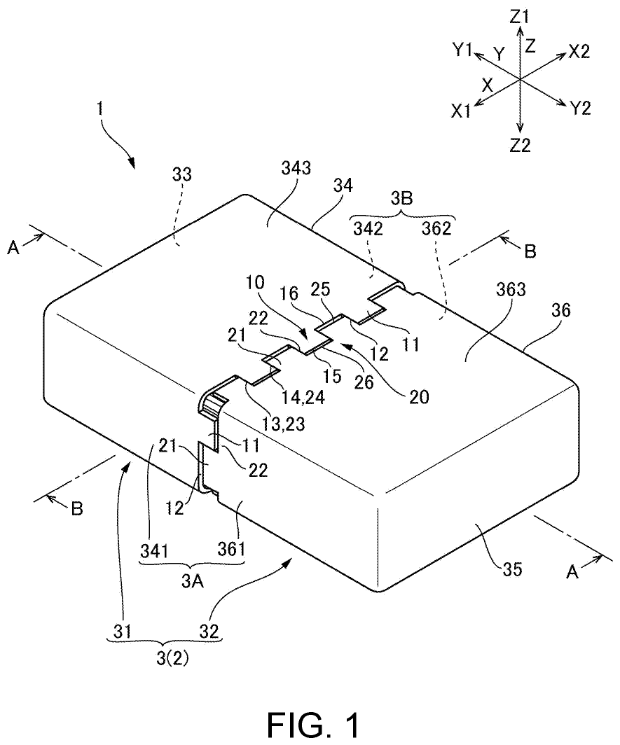

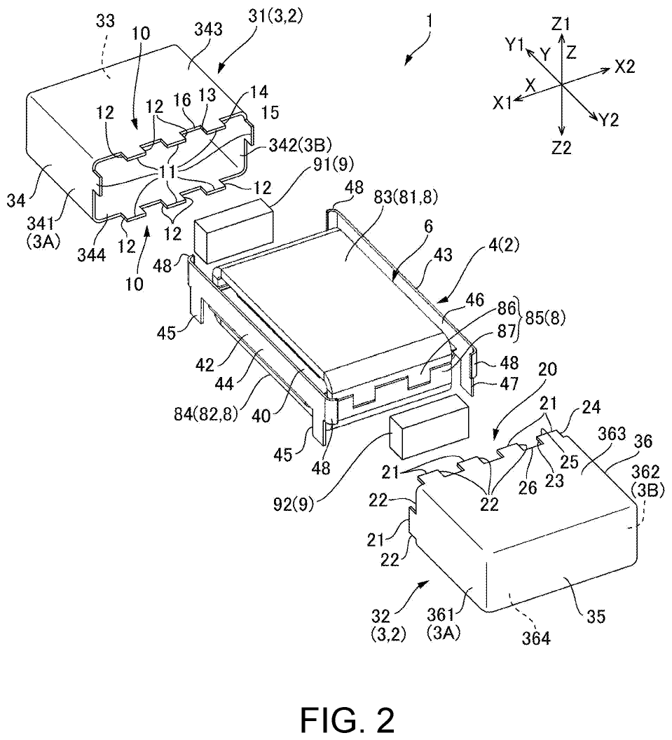

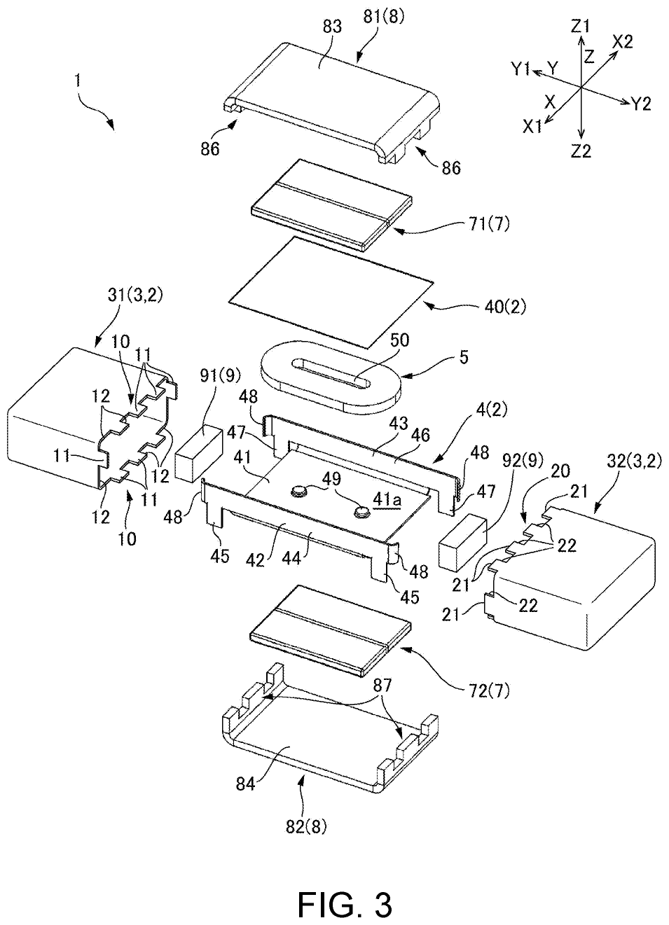

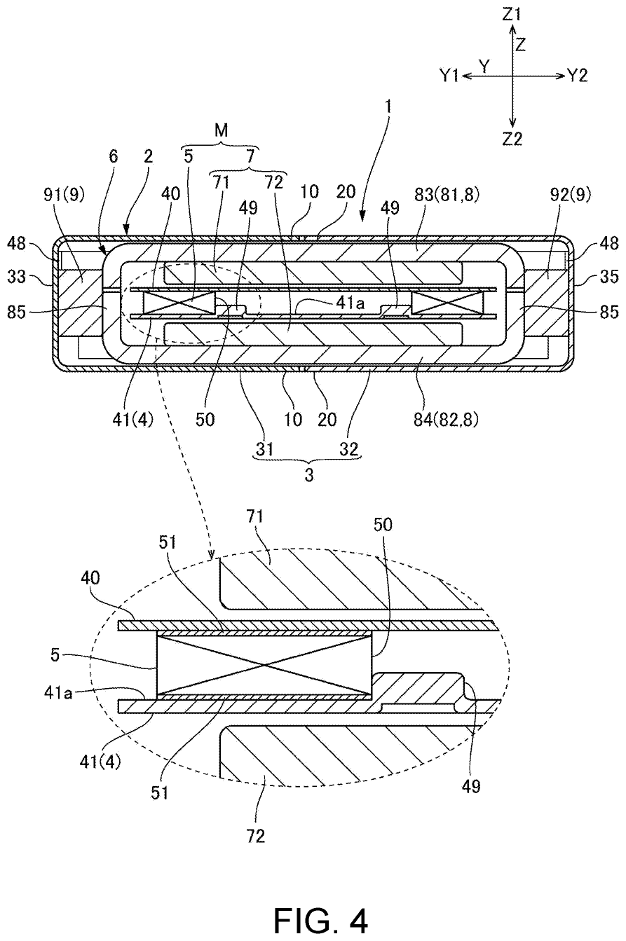

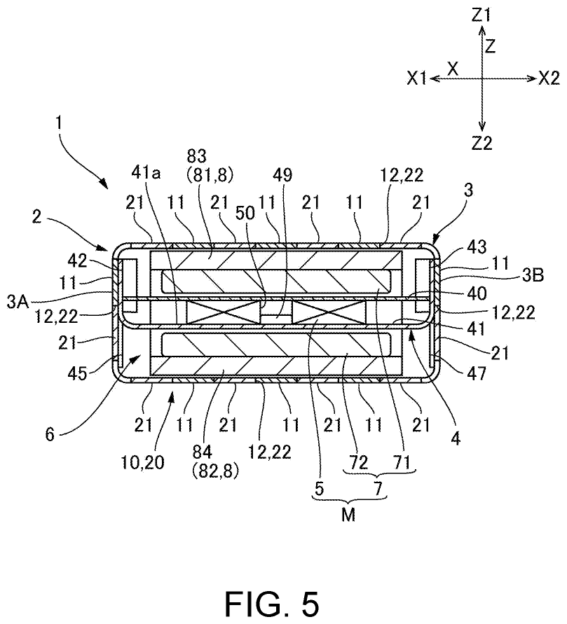

FIG. 1 is an external view of an actuator 1 to which at least an embodiment of the present invention is applied. FIG. 2 is a cross-sectional view of the actuator 1 taken along line A-A in FIG. 1. FIG. 3 is a cross-sectional view of the actuator 1 taken along line B-B in FIG. 1. FIG. 4 is an exploded view of the actuator 1 with a cover 3 disassembled. FIG. 5 is an exploded view of the actuator 1 with the cover 3 and the movable body 6 disassembled.

Overall Configuration

As illustrated in FIG. 1, the actuator 1 is rectangular in shape with its longitudinal direction oriented in the first direction Y. The actuator 1 includes a support body 2 including the cover 3 defining the outer shape of the actuator 1, and a movable body 6 supported inside the cover 3 so that it is movable in the second direction X relative to the support body 2. The support body 2 includes a cover 3, a coil holder 4, and a coil 5. The movable body 6 includes magnets 7 and a yoke 8. The coil 5 and the magnets 7 face each other in the third direction Z, and constitute a magnetic drive circuit M that vibrates the movable body 6 in the second direction X. The movable body 6 is supported by the support body 2 via a connecting member 9 that is connected to both the movable body 6 and the support body 2. The connecting member 9 includes at least one of elasticity and viscoelasticity, as described below.

The actuator 1 reports information to a user through the body of the person using the actuator 1 or a device to which the actuator 1 is attached by vibrating the movable body 6 in the second direction X. The actuator 1 can be incorporated into, for example, an operation member of a game machine, an operation panel, a steering wheel or a chair of an automobile, etc., and can be used as a tactile device to provide a user with a sense of touch by vibration of the movable body 6 in the second direction X. When the actuator 1 is used as a tactile device, for example, the AC waveform applied to the coil 5 can be adjusted to cause a difference between the acceleration of the movable body 6 moving to the first side X1 in the second direction X and the acceleration of the movable body 6 moving to the second side X2 in the second direction X. In this way, the user can feel vibration having directionality in the second direction X.

Cover

As illustrated in FIGS. 2 and 3, the cover 3 defining the outline of the actuator 1 is divided into two parts in the first direction Y. The cover 3 includes a first cover member 31 positioned at the first side Y1 in the first direction Y and a second cover member 32 positioned at the second side Y2 in the first direction Y. The first cover member 31 and the second cover member 32 are composed of a non-magnetic metal, such as stainless steel.

As illustrated in FIGS. 2 and 4, the first cover member 31 includes a rectangular first flat plate portion 33 facing the movable body 6 on the first side Y1 in the first direction Y, and a rectangular cylindrical first side plate portion 34 extending from an outer circumferential edge of the first flat plate portion 33 to the second side Y2 in the first direction Y. The corner portion connecting the outer circumferential edge of the first flat plate portion 33 and the first side plate portion 34 is curved. The first side plate portion 34 has a first side plate portion first surface 341 and a first side plate portion second surface 342 facing each other in the second direction X, and a first side plate portion third surface 343 and a first side plate portion fourth surface 344 facing each other in the third direction Z.

The distal edge of the first side plate portion 34 has extending portions 11 extending to the second side Y2 in the first direction Y. In more detail, the distal edge of the first side plate portion 34 has first comb teeth portions 10 each in which the extending portions 11 are arranged at regular intervals. In the present embodiment, the first comb teeth portions 10 are disposed at the distal edges of the first side plate portion third surface 343 and the first side plate portion fourth surface 344. The first side plate portion first surface 341 and the first side plate portion second surface 342 each have one extending portion 11. At the distal edge of the first side plate portion 34, a notched portion 12 recessed toward the first side Y1 in the first direction Y is disposed between adjacent extending portions 11. The extending portions 11 and the notched portions 12 alternate each other in each of the first comb teeth portions 10.

Each of the extending portions 11 and each of the notched portions 12 has a constant width in a direction orthogonal to the first direction Y. The edges 13 and 14 along the width direction of the two sides of each of the extending portions 11 constitute the inner edges along the width direction of each of the notched portions 12, and extend parallel to the first direction Y. The distal edge 15 of each extending portion 11 and the proximal edge 16 of each notched portion 12 on the first side Y1 in the first direction Y extend in a straight line in a direction orthogonal to the first direction Y.

The second cover member 32 includes a rectangular second flat plate portion 35 facing the movable body 6 on the second side Y2 in the first direction Y, and a rectangular cylindrical second side plate portion 36 extending from an outer circumferential edge of second flat plate portion 35 to the first side Y1 in the first direction Y. The corner portion connecting the outer circumferential edge of the second flat plate portion 35 and the second side plate portion 36 is curved. The second side plate portion 36 has a second side plate portion first surface 361 and a second side plate portion second surface 362 facing each other in the second direction X, and a second side plate portion third surface 363 and a second side plate portion fourth surface 364 facing each other in the third direction Z.

The distal edge of the second side plate portion 36 has extending portions 21 extending to the first side Y1 in the first direction Y. In more detail, the distal edge of the second side plate portion 36 has second comb teeth portions 20 each in which the extending portions 21 are arranged at regular intervals. In the present embodiment, the second comb teeth portions 20 are disposed at the distal edges of the second side plate portion third surface 363 and the second side plate portion fourth surface 364. The second side plate portion first surface 361 and the second side plate portion second surface 362 each have one extending portion 21. At the distal edge of the second side plate portion 36, a notched portion 22 recessed toward the second side Y2 in the first direction Y is disposed between adjacent extending portions 21. The extending portions 21 and the notched portions 22 alternate each other in each of the second comb teeth portions 20.

Each of the extending portions 21 and each of the notched portions 22 has a constant width in a direction orthogonal to the first direction Y. The edges 23 and 24 along the width direction of the two sides of each of the extending portions 21 constitute the inner edges along the width direction of each of the notched portions 22, and extend parallel to the first direction Y. The distal edge 25 of each extending portion 21 and the inner edge 26 of each notched portion 22 on the second side Y2 in the first direction Y extend in a straight line in a direction orthogonal to the first direction Y.

As illustrated in FIG. 1, the cover 3 is welded together in such a manner that the first comb teeth portion 10 on the first cover member 31 interlocks with the second comb teeth portion 20 on the second cover member 32. That is, the cover 3 is welded together with the extending portions 11 of the first cover member 31 fitting into the notched portions 22 of the second cover member 32 and the extending portions 21 of the second cover member 32 fitting into the notched portions 12 of the first cover member 31.

As illustrated in FIG. 1, the cover 3 has a first surface 3A and a second surface 3B facing each other in the second direction X. The first surface 3A and the second surface 3B extend parallel to each other in the first direction Y. The first surface 3A includes the first side plate portion first surface 341 of the first cover member 31 and the second side plate portion first surface 361 of the second cover member 32. The second surface 3B is composed of the first side plate portion second surface 342 of the first cover member 31 and the second side plate portion second surface 362 of the second cover member 32.

Coil Holder

As illustrated in FIG. 3, the coil holder 4 includes a rectangular coil holding portion 41 and two guide portions 42 and 43 extending in the first direction Y along the two sides of the coil holding portion 41 in the second direction X. The guide portion 42 has a flat straight portion 44 bent from an end edge of the flat coil holding portion 41 on the first side X1 in the second direction X to the first side Z1 in the third direction Z and extending along the YZ plane, and projecting portions 45 projecting from an edge of the straight portion 44 on the second side Z2 in the third direction Z to the second side Z2. The projecting portions 45 are provided at two position on the two sides of the coil holding portion 41 in the first direction Y.

Similarly, the guide portion 43 has a flat straight portion 46 bent from an end edge of the flat coil holding portion 41 on the second side X2 in the second direction X to the first side Z1 in the third direction Z and extending along the YZ plane, and projecting portions 47 projecting from an edge of the straight portion 46 on the second side Z2 in the third direction Z to the second side Z2. The projecting portions 47 are provided at two position on the two sides of the coil holding portion 41 in the first direction Y. The straight portions 44 and 46 extend parallel to each other in the first direction Y. Curved portions 48 that curve inwardly in the width direction (i.e., the second direction X) of the coil holder 4 are disposed at the two ends of each of the straight portions 44 and 46 in the first direction Y.

The coil holding portion 41 include projecting portions 49 projecting to the first side Z1 in the third direction Z. The surface of the first side Z1 of the coil holding portion 41 is a coil contacting surface 41a to which the coil 5 contacts, and the projecting portions 49 protrude from the coil contacting surface 41a. The coil holder 4 is a sheet metal member composed of a non-magnetic metal, such as stainless steel, and the projecting portions 49 are formed by press working. The coil 5 is a long, circular, air core coil, and the coil wire is wound around a long, an opening 50. The projecting portions 49 are disposed two positions spaced apart in the first direction Y. As illustrated in FIG. 4, the projecting portions 49 are inserted into the opening 50 at the two ends in the first direction Y to position the coil 5 in a state in which two effective edges extending parallel to each other in the first direction Y are aligned in the second direction X. The projecting portions 49 are each circular in shape viewed from the third direction Z, and the outer circumferential surfaces of the projecting portions 49 are in contact with the inner circumferential surface of the opening 50 (see FIGS. 4 and 5).

As illustrated in FIG. 5, the two guide portions 42 and 43 are in contact with the inner surface of the cover 3 in the second direction X and are fixed to the cover 3 by welding or an adhesive agent. In more detail, the guide portion 42 is in surface contact with the first surface 3A of the cover 3 and is fixed to the first surface 3A by welding or an adhesive agent. The guide portions 43 is in surface contact with the second surface 3B of the cover 3 and is fixed to the second surface 3B by welding or an adhesive agent. Fixing of the two guide portions 42 and 43 to the cover 3 fixes the coil 5 to the cover 3 via the coil holder 4.

In the present embodiment, since the coil holder 4 and the cover 3 are composed of metal, the portion where the two guide portions 42 an, 43 and the first surface 3A and the second surface 3B of the cover 3 are in surface contact with each other serves as a heat transfer path for transferring heat of the coil 5 to the cover 3 through the coil holder 4. As illustrated in FIG. 4, the coil 5 is fixed to the coil holding portion 41 by a heat-conductive adhesive agent 51. The heat-conductive adhesive agent 51 is, for example, an adhesive agent mixed with a paste having high thermal conductivity, such as a silver paste. The heat generated when the coil 5 is energized is transmitted to the coil holding portion 41 through the heat-conductive adhesive agent 51, is transmitted from the coil holding portion 41 to the guide portions 42 and 43, and is dissipated to the outside through the cover 3, which is in surface contact with the guide portions 42 and 43.

Plate

As illustrated in FIGS. 4 and 5, the support body 2 includes a plate 40 that overlaps the coil 5 from the first side Z1 in the third direction Z. As illustrated in FIG. 3, the plate 40 is a rectangular metal plate and is composed of a non-magnetic material. The plate 40 is fixed to the coil 5 with the heat-conductive adhesive agent 51. The coil 5 is disposed between the coil holding portion 41 and the plate 40. Therefore, when the actuator 1 is subjected to a shock due to a fall or the like and the movable body 6 moves significantly, the coil 5 is prevented from colliding with the magnets 7 and being damaged.

Movable Body

As illustrated in FIGS. 3, 4, and 5, the present embodiment includes a first permanent magnet 71 and a second permanent magnet 72 as the magnets 7. The first permanent magnet 71 faces the coil 5 at the first side Z1 in the third direction Z, and the second permanent magnet 72 faces the coil 5 at the second side Z2 in the third direction Z. The first permanent magnet 71 and the second permanent magnet 72 are respectively magnetized to different poles on the first side X1 in the second direction X and on the second side X2 in the second direction X.

The yoke 8 is composed of a magnetic metal and holds the magnets 7. As illustrated in FIG. 4, the yoke 8 is composed of two members, a first yoke member 81 and a second yoke member 82, assembled together. The first yoke member 81 has a flat first plate portion 83. The second yoke member 82 has a second plate portion 84 facing the first plate portion 83 in the third direction Z. The first plate portion 83 and the second plate portion 84 has a substantially rectangular shape with the first direction Y as the longitudinal direction. As illustrated in FIGS. 4 and 5, the first permanent magnet 71 is held on a surface of the first plate portion 83 on the second side Z2 in the third direction Z. The second permanent magnet 72 is held on a surface of the second plate portion 84 on the first side Z1 in the third direction Z.

The yoke 8 has two connecting portions 85 that connect the first plate portion 83 and the second plate portion 84 at two positions separated in the second direction X. The two connecting portions 85 face each other in the second direction X across the coil 5 and the magnets 7. The connecting portions 85 are plate portions orthogonal to the second direction X. Here, the first yoke member 81 has two first yoke side comb teeth portions 86 that bend from the two ends of the first plate portion 83 in the first direction Y to the second side Z2 in the third direction Z and project to the second side Z2. Here, the second yoke member 82 has two second yoke side comb teeth portions 87 that bend from the two ends of the second plate portion 84 in the first direction Y to the first side Z1 in the third direction Z and project to the first side Z1. In the present embodiment, each of the connecting portions 85 is joined into a plate by interlocking and welding the first yoke side comb teeth portions 86 of the first yoke member 81 and the second yoke side comb teeth portions 87 of the second yoke member 82.

As illustrated in FIG. 5, the width in the second direction X of the yoke 8 and the magnets 7 is smaller than the spacing of the two guide portions 42 and 43 in the second direction X. Therefore, the movable body 6 is disposed between the two guide portions 42 and 43 in a state in which it can vibrate in the second direction X.

Connecting Element

The movable body 6 is supported in such a manner that it is movable in the second direction X by a connecting member 9 disposed between the movable body 6 and the support body 2. In the present embodiment, the connecting member 9 includes a first connecting sub-member 91 disposed on the first side Y1 of the movable body 6 in the first direction Y and a second connecting sub-member 92 disposed on the second side Y2 of the movable body 6 in the first direction Y. The first connecting sub-member 91 connects the first flat plate portion 33 of the cover 3 constituting the support body 2 and the corresponding connecting portion 85 of the yoke 8 on the first side Y1 at the portion where these face each other in the first direction Y. The second connecting sub-member 92 connects the second flat plate portion 35 of the cover 3 and the corresponding connecting portion 85 of the yoke 8 on the second side Y2 at the portion where these face each other in the first direction Y.

The two sides of the first connecting sub-member 91 and the two sides of the second connecting sub-member 92 in the first direction Y are connected to the movable body 6 and the support body 2 by adhesion or the like. The first connecting sub-member 91 and the second connecting sub-member 92 are in a state of being compressed in the first direction Y between the support body 2 and the movable body 6. That is, the first connecting sub-member 91 is compressed in the first direction Y between the first flat plate portion 33 and the connecting portion 85 on the first side Y1 of the yoke 8. The second connecting sub-member 92 is compressed in the first direction Y between the second flat plate portion 35 and the connecting portion 85 on the second side Y2 of the yoke 8.

The connecting member 9 has at least one of elasticity and viscoelasticity. In the present embodiment, the connecting member 9 is a viscoelastic member. For example, the connecting member 9 (viscoelastic member) is a gelatinous member composed of silicone gel or the like. In the present embodiment, the connecting member 9 is composed of a silicone gel having a needle penetration of 10 to 110 degrees. Needle penetration is specified in JIS-K-2207 and JIS-K-2220, and the smaller this value is, the harder the material is. Examples of materials of the connecting member 9 having viscoelasticity include various rubber materials such as natural rubber, diene-based rubber (e.g., styrene-butadiene rubber, isoprene rubber, butadiene rubber, chloroprene rubber, acrylonitrile butadiene rubber), non-diene-based rubber (e.g., butyl rubber, ethylene-propylene rubber, ethylene-propylene-diene rubber, urethane rubber, silicone rubber, fluororubber), thermoplastic elastomers, and modified materials thereof.

The connecting member 9 has linear or non-linear stretching characteristics depending on the stretching direction. For example, the stretching characteristics of compressive deformation of the connecting member 9 in the thickness direction (axial direction) has a non-linear component (spring modulus) larger than the linear component (spring modulus), whereas the stretching characteristics of elongation of the connecting member 9 in the thickness direction (axial direction) has a linear component (spring modulus) larger than the non-linear component (spring modulus). When the deformation characteristic of the connecting member 9 in a direction (shear direction) intersecting the thickness direction (axial direction) has a linear component (spring modulus) larger than a nonlinear component (spring modulus) because the deformation is in the direction the connecting member 9 is being pulled and stretched, regardless of the direction of movement of the connecting member 9.

In the present embodiment, the connecting member 9 deform in the shear direction when the movable body 6 vibrates in the second direction X. Therefore, when the movable body 6 vibrates in the second direction X in the connecting member 9, the vibration can be generated with subtle nuances because the reproducibility of the vibration acceleration in response to the input signal can be improved through use of a spring element in the shear direction.

Actuator Assembly Method

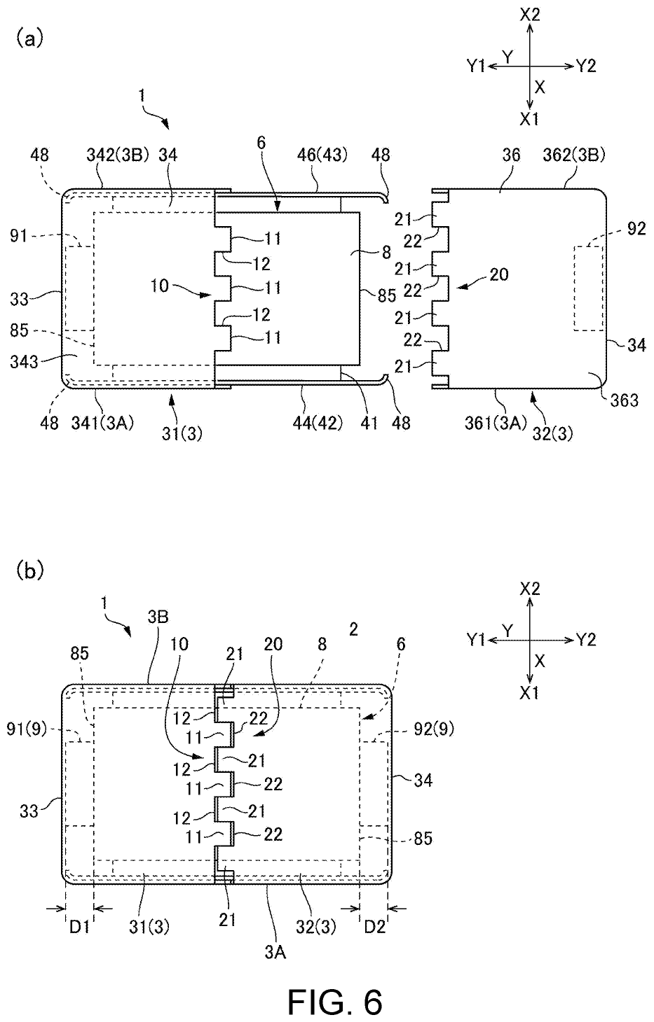

FIG. 6 illustrates an assembly method of the cover 3. (a) of FIG. 6 illustrates a state in which the first side Y1 portions of the coil holder 4 and the movable body 6 are inserted into the first cover member 31, and (b) of FIG. 6 illustrates a state in which the second side Y2 portions of the coil holder 4 and the movable body 6 are inserted into the second cover member 32 and the first comb teeth portion 10 and the second comb teeth portion 20 are engaged.

When the actuator 1 is to be assembled, first, the coil holder 4, the coil 5, and the plate 40 are assembled, and then the movable body 6 is assembled to the state illustrated in FIG. 2. When the coil holder 4, the coil 5, and the plate 40 are assembled, the projecting portions 49 are fitted into the opening 50 of the coil 5 so that the coil 5 come into contact with the coil contacting surface 41a, and then the plate 40 is disposed in contact with the coil 5 from the first side Z1 in the third direction Z. As illustrated in FIG. 4, the heat-conductive adhesive agent 51 is applied between the coil contacting surface 41a and the end face of the coil 5, and between the end face of the coil 5 and the plate 40. This fixes the coil 5 to the coil holding portion 41. The plate 40 is fixed to the coil holder 4 via the coil 5. Note that the inside of the opening 50 may be filled with the heat-conductive adhesive agent 51.

After that, the first permanent magnet 71 fixed to the first yoke member 81 faces the plate 40 from the first side Z1 in the third direction Z, and the second permanent magnet 72 fixed to the second yoke member 82 faces the coil holding portion 41 from the second side Z2 in the third direction Z. The yoke 8 is then assembled by interlocking and welding the first yoke side comb teeth portions 86 and the second yoke side comb teeth portions 87. In this way, the movable body 6 is assembled so as to be movable in the second direction X relative to the coil holder 4, and the magnet 7 and the coil 5 constitute the magnetic drive circuit M.

Next, the support body 2 is assembled, and the movable body 6 is connected with the support body 2 by the connecting member 9. The connecting member 9 is preliminarily fixed to the cover 3 or preliminarily fixed to the yoke 8 before the coil holder 4, the first cover member 31, and the second cover member 32 are assembled. In the present embodiment, the first connecting sub-member 91 is preliminarily joined to the first flat plate portion 33, and the second connecting sub-member 92 is preliminarily joined to the second flat plate portion 35. The coil holder 4 is then inserted into the first cover member 31 from the second side Y2 in the first direction Y. The movable body 6 is inserted into the first cover member 31 together with the coil holder 4. As illustrated in (a) of FIG. 6, the movable body 6 is inserted so that it comes into contact with the first connecting sub-member 91, and the movable body 6 is fixed to the first connecting sub-member 91 with an adhesive agent or the like, thereby connecting the movable body 6 to the support body 2 by the first connecting sub-member 91.

As illustrated in (a) of FIG. 6, when the coil holder 4 is inserted into the first cover member 31, the two guide portions 42 and 43 come into contact with the first side plate portion first surface 341 and the first side plate portion second surface 342 from the inside, so that the insertion of the coil holder 4 into the first cover member 31 is guided. The coil holder 4 is inserted into the first cover member 31 until the curved portions 48 provided at the distal ends of the two guide portions 42 and 43 on the first side Y1 strike the corner portion at which the first flat plate portion 33 and the first side plate portion 34 are connected.

Subsequently, the second cover member 32 is brought closer to the first cover member 31 from the second side Y2 in the first direction Y, and the coil holder 4 and the movable body 6 are inserted into the second cover member 32 to interlock the first comb teeth portion 10 and the second comb teeth portion 20. At this time, the two guide portions 42 and 43 come into contact with the second side plate portion first surface 361 and the second side plate portion second surface 362 from the inside, so that the insertion of the coil holder 4 into the second cover member 32 is guided.

The first comb teeth portion 10 and the second comb teeth portion 20 engage in a slidable state in the first direction Y because the extending portions 11 slidably fit into the notched portions 22 and the extending portions 21 slidably fit into the notched portions 12. As illustrated in (b) of FIG. 6, the second cover member 32 is slid to the first side Y1 until the second connecting sub-member 92 fixed to the second cover member 32 comes into contact with the movable body 6, and the movable body 6 is fixed to the second connecting sub-member 92 by an adhesive agent or the like. This connects the movable body 6 and the support body 2 by the second connecting sub-member 92.

Before the first cover member 31 and the second cover member 32 are welded and permanently fixed, a distance D1 between the first flat plate portion 33 and the movable body 6 (see (b) of FIG. 6) and a distance D2 between the second flat plate portion 35 and the movable body 6 (see (b) of FIG. 6) are adjusted so that the first connecting sub-member 91 and the second connecting sub-member 92 are compressed as designed. In the present embodiment, since the first comb teeth portion 10 and the second comb teeth portion 20 are engaged in a state slidable in the first direction Y, the first cover member 31 and the second cover member 32 can adjust the amount of engagement of the first comb teeth portion 10 and the second comb teeth portion 20. The distances D1 and D2 are adjusted so that the spring force applied to the movable body 6 from the first connecting sub-member 91 and the spring force applied to the movable body 6 from the second connecting sub-member 92 are balanced.

For example, the coil 5 is energized and the vibration characteristics of the movable body 6 are measured while the first cover member 31 and the second cover member 32 temporarily fixed. The amount of engagement between the first comb teeth portion 10 and the second comb teeth portion 20 is adjusted so that the vibration characteristics as designed are achieved. If the vibration characteristics are as designed, it is determined that the distances D1 and D2 have the dimensions as designed. The first cover member 31 and the second cover member 32 are then welded and permanently fixed in the arrangement that achieves the vibration characteristics as designed. Note that in place of measuring the vibration characteristics of the movable body 6, the distances D1 and D2 may be measured using a contact displacement meter or the like to adjust the amount of engagement of the first comb teeth portion 10 and the second comb teeth portion 20.

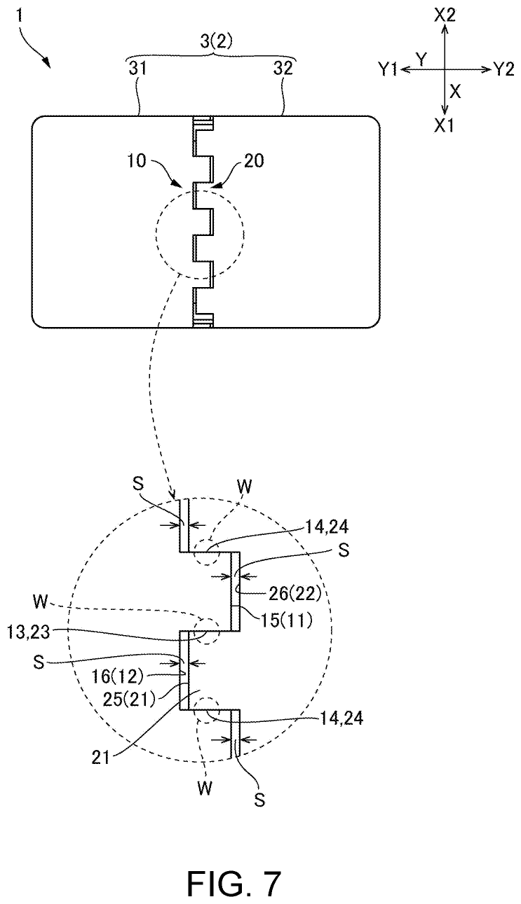

FIG. 7 illustrates welded portions of the first comb teeth portion 10 and the second comb teeth portions 20. In the present embodiment, as a result of adjusting the relative positions of the first cover member 31 and the second cover member 32 to achieve the vibration characteristics as designed, the first comb teeth portion 10 and the second comb teeth portion 20 have gaps S in the first direction Y between the distal edges 15 of the extending portions 11 and the inner edges 26 of the notched portions 22, and between the distal edges 25 of the extending portions 21 and the inner edges 16 of the notched portion 12. The gaps S vary in accordance with variations in the dimensions of the cover 3, the yoke 8, and the connecting member 9.

The first cover member 31 and the second cover member 32 are joined by welding the portions at which the widthwise edges 13 and 14 of the extending portions 11 and the widthwise edges 23 and 24 of the notched portions 22 come into contact. As in the enlarged view in FIG. 7, weld marks W are formed on the cover 3 at the portions at which the widthwise edges 13 of the extending portions 11 come into contact with the edges 23 of the notched portions 22, and at the portions at which the widthwise edges 14 of the extending portions 11 come into contact with the edges 24 of the notched portions 22.

Note that in the present embodiment, as described above, the widthwise edges 13 and 14 of the extending portions 11 constitute the widthwise edges of the notched portions 12, and the widthwise edges 23 and 24 of the notched portions 22 constitute the widthwise edges of the extending portions 21. Therefore, the welded portions of the first cover member 31 and the second cover member 32 are the portions at which the widthwise edges 23 and 24 of the extending portions 21 and the widthwise edges 13 and 14 of the notched portions 12 come into contact.

Main Advantageous Effects of the Present Embodiment

As described above, the actuator 1 of the present embodiment includes a movable body 6, a support body 2 including a cover 3 enclosing the movable body 6, a connecting member 9 having at least one of elasticity and viscoelasticity and being connected to both the movable body 6 and the support body 2, and a magnetic drive circuit M. The cover 3 consists of a first cover member 31 having a first flat plate portion 33, and a second cover member 32 having a second flat plate portion 35 facing the first flat plate portion 33 in the first direction Y. The magnetic drive circuit M vibrates the movable body 6 disposed between the first flat plate portion 33 and the second flat plate portion 35 in the second direction X intersecting the first direction Y. The connecting member 9 includes a first connecting sub-member 91 disposed between the movable body 6 and the first flat plate portion 33, and a second connecting sub-member 92 disposed between the movable body 6 and the second flat plate portion 35. The first cover member 31 has a first side plate portion 34 extending from an edge of the first flat plate portion 33 toward the second cover member 32, and the distal edge of the first side plate portion 34 has extending portions 11 projecting in the first direction Y. The second cover member 32 has a second side plate portion 36 extending from an edge of the second flat plate portion 35 toward the first cover member 31, and the distal edge of the second side plate portion 36 includes notched portions 22 into which the extending portions 11 are slidably fitted in the first direction Y.

In the present embodiment, the cover 3 constituting the support body 2 in this way includes the first cover member 31 and the second cover member 32 joined together. The first cover member 31 and the second cover member 32 are assembled such that extending portions 11 of the first cover member 31 are slidably fitted to the notched portions 22 of the second cover member 32 in the first direction Y. Therefore, since the distance between the first flat plate portion 33 of the first cover member 31 and the second flat plate portion 35 of the second cover member 32, which are disposed on both side of the movable body 6 in the first direction Y, can be finely adjusted, the dimensional accuracy of the gap in which the connecting member 9 is disposed can be increased even if the dimensional accuracy of the parts is low. This enables firm connection between the movable body 6 and the support body 2 by the connecting member 9, so that defective assembly can be avoided. Moreover, excess compression of the connecting member 9 can be avoided. Therefore, it is possible to manufacture an actuator 1 that achieves vibration characteristics as designed.

In the present embodiment, the distal edge of the first side plate portion 34 is provided with the first comb teeth portion 10 in which the extending portions 11 are disposed at regular intervals. The distal edge of the second side plate portion 36 is provided with the second comb teeth portion 20 in which notched portions 22 are disposed in regular intervals. The second comb teeth portion 20 engages with the first comb teeth portion 10 in a manner slidable in the first direction Y. In this way, if the comb teeth portions are engaged with each other, the assembled first cover member 31 and second cover member 32 do not readily shift in a direction intersecting the first direction Y. Therefore, the first cover member 31 and the second cover member 32 can be permanently fixed together through ready work, such as welding. Moreover, the work of adjusting the distance between the first flat plate portion 33 and the second flat plate portion 35 can be readily performed while measuring the vibration characteristics before the first cover member 31 and the second cover member 32 are to be permanently fixed.

In the present embodiment, the widthwise edges 13 and 14 of the extending portions 11 and the widthwise edges 23 and 24 of the notched portions 22 are welded together to join the first cover member 31 and the second cover member 32. Therefore, even when the first cover member 31 and the second cover member 32 are shifted in the first direction Y, they can be joined. Furthermore, reduction in the joining strength due to the shift of the first cover member 31 and the second cover member 32 in the first direction Y can be avoided.

In the present embodiment, the first side plate portion 34 cylindrically extends to the second side Y2 in the first direction Y from the outer circumferential edge of the first flat plate portion 33, and the second side plate portion 36 cylindrically extends to the first side Y1 in the first direction Y from the outer circumferential edge of the second flat plate portion 35. Therefore, the cover 3 in a sealed form can be readily assembled by joining together the distal edges of the cylindrical portions. The sealed form of the cover 3 can prevent the entering of foreign matter into the cover 3.

In the present embodiment, the movable body 6 includes a yoke 8 having a first plate portion 83 extending in the first direction Y, a second plate portion 84 facing the first plate portion 83 in a third direction Z intersecting the first direction Y and the second direction X. The support body 2 includes a coil holder 4 disposed between the first plate portion 83 and the second plate portion 84. The magnetic drive circuit M includes a coil 5 held in the coil holder 4, and a magnet 7 that is fixed to at least one of the first plate portion 83 and the second plate portion 84 and faces the coil 5 in the third direction Z. The yoke 8 includes two connecting portions 85 connecting the first plate portion 83 and the second plate portion 84 and facing each other in the second direction X across the coil 5 and the magnet 7. The first connecting sub-member 91 connects one of the connecting portions 85 and the first flat plate portion 33, and the second connecting sub-member 92 connects the other one of the connecting portions 85 and the second flat plate portion 35. Through such a configuration, the magnetic drive circuit M can include the magnet 7 disposed in the movable body 6 and the coil 5 disposed in the support body 2 arranged in a direction intersecting the vibration direction. By enclosing the magnet 7 and the coil 5 by the yoke 8, the magnetic efficiency can be increased.

In the present embodiment, the coil holder 4 includes a coil holding portion 41 disposed between the first plate portion 83 and the second plate portion 84, and two guide portions 42 and 43 erected in the third direction Z from the two ends in the second direction X of the coil holding portion 41 and extending in the first direction Y on both sides in the second direction X of the yoke 8. The first side plate portion 34 has a first side plate portion first surface 341 and a first side plate portion second surface 342 facing each other in the second direction X, and the second side plate portion 36 has a second side plate portion first surface 361 and a second side plate portion second surface 362 facing each other in the second direction X. The guide portion 42 on the first side X1 comes into contact with the first side plate portion first surface 341 and the second side plate portion first surface 361, and the guide portion 43 on the second side X2 come into contact with the first side plate portion second surface 342 and the second side plate portion second surface 362. In this way, in the present embodiment, since the coil holder 4 includes the two guide portions 42 and 43, the insertion of the coil holder 4 into the first cover member 31 and the second cover member 32 can be guided during assembly of the support body 2. Therefore, assembly of the support body 2 is easy. Furthermore, the coil holder 4 can be positioned inside the cover 3.

In the present embodiment, the cover 3 and the coil holder 4 are composed of metal. Since the heat of the coil 5 can be dissipated from the cover 3 through the coil holder 4, the dissipation can be enhanced, and the temperature rise of the coil 5 can be suppressed. This reduces the risk of the coil 5 exceeding the upper temperature limit when a large current is applied, so that a large current can be applied and the driving force of the magnetic drive circuit M can be increased. Therefore, it is possible to obtain the actuator 1 capable of generating strong vibration. Furthermore, variations in vibration characteristics due to heat can be suppressed.

Modification

(1) In the above embodiment, the distal edges of the first side plate portion third surface 343 and the first side plate portion fourth surface 344 at the distal edge on the second side Y1 of the first cover member 31 has the first comb teeth portion 10 in which multiple extending portions 11 are arranged at regular intervals. However, the number and arrangement of the extending portions 11 disposed at the distal edges of respective surfaces can be modified as appropriate. For example, the extending portions 11 at the distal edges of the respective surface may be provided at only one location and may not be arranged in a comb-like pattern. In the above embodiment, the extending portions 11 are provided on all four surfaces: the first side plate portion first surface 341, the first side plate portion second surface 342, the first side plate portion third surface 343, and the first side plate portion fourth surface 344. However, the extending portions 11 may be provided on only one or some of the four surfaces. For example, one or more extending portions 11 may be disposed on only two surfaces: the first side plate portion third surface 343 and the first side plate portion fourth surface 344. The number and arrangement of the extending portions 21 at the distal edge on the first side Y1 of the second cover member 32 can also be modified.

(2) In an above-described embodiment, the magnets 7 (the first permanent magnets 71 and the second permanent magnets 72) are disposed on both sides of the coil 5 in the third direction Z. However, at least an embodiment of the present invention is applicable to an actuator including a magnet 7 disposed only on a first side Z1 or a second side Z2 in the third direction Z relative to the coil 5. At least an embodiment of the present invention applicable to an actuator including multiple pairs of coils 5 and magnets 7 facing each other in a third direction Z. When multiple pairs of coils 5 and magnets 7 are provided, it is preferable to provide projecting portions 49 at positions where the projecting portions 49 fit into the opening 50 of each coil 5.

(3) In the magnetic drive circuit M of the above embodiment, the magnet 7 is disposed adjacent to the support body 2, and the coil 5 is disposed adjacent to the movable body 6. However, at least an embodiment of the present invention can be applied to an actuator in which the coil 5 is disposed adjacent to the support body 2, and the magnet 7 is disposed adjacent to the movable body 6.

What is claimed is:

1. An actuator comprising:
a movable body;
a support body comprising a cover enclosing the movable body;
a connecting member having at least one of elasticity and viscoelasticity and being connected to both the movable body and the support body; and
a magnetic drive circuit,
the cover comprising:
a first cover member having a first flat plate portion; and
a second cover member having a second flat plate portion facing the first flat plate portion in a first direction,
the magnetic drive circuit vibrating the movable body disposed between the first flat plate portion and the second flat plate portion in a second direction intersecting the first direction,
the connecting member comprising a first connecting sub-member disposed between the movable body and the first flat plate portion and a second connecting sub-member disposed between the movable body and the second flat plate portion,
the first cover member comprising a first side plate portion extending from an edge of the first flat plate portion toward the second cover member,
a distal edge of the first side plate portion comprising extending portions extending in the first direction,
the second cover member comprising a second side plate portion extending from an edge of the second flat plate portion toward the first cover member,
a distal edge of the second side plate portion comprising notched portions in which the extending portions are slidably fitted in the first direction.

2. The actuator according to claim 1, wherein,
the distal edge of the first side plate portion comprises a first comb teeth portion in which the extending portions are arrayed at regular intervals, and
the distal edge of the second side plate portion comprises a second comb teeth portion in which the notched portions are arrayed at regular intervals, the second comb teeth portion engaging the first comb teeth portion while slidable in the first direction.

3. The actuator according to claim 1, wherein the first cover member and the second cover member are joined by welding widthwise edges of the extending portions and widthwise edges of the notched portions.

4. The actuator according to claim 1, wherein,
the first side plate portion extends cylindrically in the first direction from an outer circumferential edge of the first flat plate portion, and
the second side plate portion extends cylindrically in the first direction from an outer circumferential edge of the second flat plate portion.

5. The actuator according to claim 1, wherein,
the movable body comprises:
a yoke having a first plate portion extending in the first direction; and
a second plate portion facing the first plate portion in a third direction intersecting the first direction and the second direction,
the support body comprises a coil holder disposed between the first plate portion and the second plate portion,
the magnetic drive circuit includes a coil held by the coil holder, and a magnet fixed to at least one of the first plate portion and the second plate portion and facing the coil in the third direction,
the yoke comprises two connecting portions connecting the first plate portion and the second plate portion and facing each other in the second direction across the coil and the magnet,
the first connecting sub-member connects one of the two connecting portions to the first flat plate portion, and
the second connecting sub-member connects the other one of the two connecting portions to the second flat plate portion.

6. The actuator according to claim 5, wherein,
the coil holder comprises:
a coil holding portion disposed between the first plate portion and the second plate portion; and
two guide portions being erected in the third direction from both ends in the second direction of the coil holding portion and extending in the first direction on both sides in the second direction of the yoke,
the first side plate portion has a first side plate portion first surface and a first side plate portion second surface facing each other in the second direction,
the second side plate portion has a second side plate portion first surface and a second side plate portion second surface facing each other in the second direction,
one of the two guide portions is in contact with the first side plate portion first surface and the second side plate portion first surface, and
the other one of the two guide portions is in contact with the first side plate portion second surface and the second side plate portion second surface.

7. The actuator according to claim 6, wherein the cover and the coil holder comprise metal.
